(19) United States
(12) Patent Application Publication
(10) Pub. No.: US 2005/0125656 A1
(43) Pub. Date: Jun. 9, 2005

(54) Electronic notary system and method for long-term digital signature authentication

(76) Inventors: Rizwan Mallal, Newton, MA (US); Walid Negm, Brookline, MA (US)

Correspondence Address: MORRISS O'BRYANT COMPAGNI, P.C., 136 SOUTH MAIN STREET, SUITE 700, SALT LAKE CITY, UT, 84101, US

(21) Appl. No.: 10/869,490

(22) Filed: Jun. 16, 2004

Related U.S. Application Data
(60) Provisional application No. 60/478,912, filed on Jun. 16, 2003.

(51) Int. Cl. H04L 9/00

(52) U.S. Cl. 713/156

(57) ABSTRACT

A system for verification of a digital signature when 1) a digital certificate has expired and not been renewed, 2) a signatory has left or has a different position within an organization, or 3) the signing entity is no longer in existence, wherein the system eliminates the need to renew digital certificates, while still providing long-term authentication of digital signatures.

### CROSS-REFERENCE TO RELATED APPLICATION

This is a non-provisional application claiming priority to provisional application Ser. No. 60/478,912 filed Jun. 16, 2003.

### BACKGROUND OF THE INVENTION

1. Field of the Invention

This invention relates generally to digital signatures. More specifically, the invention relates to a system and method for being able to verify a digital signature even after a digital certificate that verifies the digital signature has expired.

2. Description of Related Art

It is necessary to understand several digital signature concepts in order to realize the benefits of the present invention. Beginning with signatures in general, it is recognized that a manuscript signature has served the purposes of 1) providing evidence as to the maker of a document, 2) expressing the signatory's approval of the content of the document or the intention that the document should have legal effect, and 3) calling to the attention of the signatory the significance of the act of signing, and therefore helping prevent the signatory from entering into commitments without due consideration of what he or she is doing.

Digital signature technology can perform the same functions of a manuscript signature, and can produce evidence of the integrity of a signed electronic document that is more reliable. Increased reliability comes not only from being able to prove that the person who purports to be the signatory has signed the electronic document, but also that the content of the electronic document is what the signatory signed.

Accordingly, a digital signature is an electronic signature that can be used to authenticate the identity of the sender of a message or the signer of a document, and possibly to ensure that the original content of the message or document that has been sent is unchanged. Digital signatures are easily transportable, cannot be imitated by someone else, and can be automatically time-stamped. The ability to ensure that the original signed message arrived means that the sender cannot easily repudiate it later. A digital signature can also be used with any kind of document or message, whether or not it is encrypted, simply so that the receiver can be sure of the signer's or sender's identity and that the document or message is intact. Digital signatures use what is known as public key cryptography, which employs an algorithm using two different but mathematically related keys. One key is used for creating a digital signature or transforming data into a seemingly unintelligible form, and another key is used for verifying a digital signature or returning the message to its original form.

The keys used for digital signatures are arbitrarily termed the private key, which is known only to the signer and used to create the digital signature, and the public key, which is ordinarily more widely known and is used by a relying party to verify the digital signature. If many people need to verify the signer's digital signatures, the public key must be available or distributed to all of them, perhaps by publication in an on-line repository or directory where it is easily accessible. Although the keys of the pair are mathematically related, it is computationally infeasible to derive the private key from knowledge of the public key. Thus, although many people may know the public key of a given signer and use it to verify that signer's signatures, they cannot discover that signer's private key and use it to forge digital signatures.

Another fundamental process, termed a hash function, is used in both creating and verifying a digital signature. A hash function is an algorithm which creates a digital representation or fingerprint in the form of a hash value or hash result of a standard length which is usually much smaller than the message but nevertheless substantially unique to it. Any change to the message invariably produces a different hash result when the same hash function is used. In the case of a secure hash function, sometimes termed a one-way hash function, it is computationally infeasible to derive the original message from knowledge of its hash value.

Digital signature creation uses a hash result derived from and unique to both the signed message and a given private key. Digital signature verification is the process of checking the digital signature by reference to the original message and a given public key, thereby determining whether the digital signature was created for that same message using the private key that corresponds to the referenced public key.

To sign a document or any other item of information, the signer first determines what is to be signed. The information to be signed is termed the message. Then a hash function in the signer's software computes a hash result unique, for all practical purposes, to the message. The signer's software then transforms the hash result into a digital signature using the signer's private key. The resulting digital signature is thus unique to both the message and the private key used to create it.

Typically, a digital signature (a digitally signed hash result of the message) is attached to its message and stored or transmitted with its message. However, it may also be sent or stored as a separate data element, so long as it maintains a reliable association with its message. Because a digital signature is unique to its message, it is useless if wholly disassociated from its message.

Verification of a digital signature is accomplished by computing a new hash result of the original message by means of the same hash function used to create the digital signature. Then, using the public key and the new hash result, the verifier checks: 1) whether the digital signature was created using the corresponding private key; and 2) whether the newly computed hash result matches the original hash result which was transformed into the digital signature during the signing process.

The verification software will confirm the digital signature as “verified” if: 1) the signer's private key was used to digitally sign the message, which is known to be the case if the signer's public key was used to verify the signature because the signer's public key will verify only a digital signature created with the signer's private key; and 2) the message was unaltered, which is known to be the case if the hash result computed by the verifier is identical to the hash result extracted from the digital signature during the verification process.

A digital signature should not be confused with the concept of a digital certificate. A digital certificate contains the digital signature of a certificate-issuing authority so that anyone can verify that the digital certificate is valid. A digital certificate is issued by a certification authority, and typically contains a name, a serial number, expiration dates, a copy of the certificate holder's public key (used for encrypting messages and digital signatures), and the digital signature of the certificate-issuing authority so that a recipient can verify the authenticity of the certificate. Digital certificates can be kept in registries so that authenticating users can look up other users' public keys.

However, there is a problem inherent with a digital certificate that only becomes apparent after an examination of the digital certificate process.

As explained above, to verify a digital signature, the verifier must have access to the signer's public key and have assurance that it corresponds to the signer's private key. However, a public and private key pair has no intrinsic association with any person; it is simply a pair of numbers. Some convincing strategy is necessary to reliably associate a particular person or entity to the key pair.

In a transaction involving only two parties, each party can simply communicate (by a relatively secure “out-of-band” channel such as a courier or a secure voice telephone) the public key of the key pair each party will use. Such an identification strategy is no small task, especially when the parties are geographically distant from each other, normally conduct communication over a convenient but insecure channel such as the Internet, are not natural persons but rather corporations or similar artificial entities, and act through agents whose authority must be ascertained.

As electronic commerce increasingly moves from a bilateral setting to the many-on-many architecture of the World Wide Web on the Internet, where significant transactions will occur among strangers who have no prior contractual relationship and will never deal with each other again, the problem of authentication and nonrepudiation becomes not merely one of efficiency, but also of reliability. An open system of communication such as the Internet needs a system of identity authentication to handle this scenario.

A prospective signer might issue a public statement saying that signatures verifiable by a particular public key are reliable. However, others doing business with the signer may for good reason be unwilling to accept the statement, especially where there is no prior contract establishing the legal effect of that published statement with certainty. A party relying upon such an unsupported published statement in an open system would run a great risk of trusting a phantom or an imposter, or of attempting to disprove a false denial of a digital signature (“nonrepudiation”) if a transaction should turn out to prove disadvantageous for the purported signer.

The solution to these problems is the use of one or more trusted third parties to associate an identified signer with a specific public key. That trusted third party is referred to as a “certification authority.”

To associate a key pair with a prospective signer, a certification authority issues a digital certificate, an electronic record which lists a public key as the “subject” of the certificate, and confirms that the prospective signer identified in the certificate holds the corresponding private key. The prospective signer is termed the “subscriber.” A digital certificate's principal function is to bind a key pair with a particular subscriber. A “recipient” of the digital certificate desiring to rely upon a digital signature created by the subscriber named in the certificate (whereupon the recipient becomes a “relying party”) can use the public key listed in the certificate to verify that the digital signature was created with the corresponding private key. If such verification is successful, this chain provides assurance that the corresponding private key is held by the subscriber named in the digital certificate, and that the digital signature was created by that particular subscriber.

A digital signature, whether created by a subscriber to authenticate a message or by a certification authority to authenticate its certificate should be reliably time-stamped to allow the verifier to determine reliably whether the digital signature was created during an “operational period” stated in the certificate, which is a condition upon verifiability of a digital signature.

To make a public key and its identification with a specific subscriber readily available for use in verification, the certificate may be published in a repository or made available by other means. Repositories are on-line databases of certificates and other information available for retrieval and use in verifying digital signatures. Retrieval can be accomplished automatically by having the verification program directly inquire of the repository to obtain certificates as needed.

Once issued, a digital certificate may prove to be unreliable, such as in situations where the subscriber misrepresents his identity to the certification authority. In other situations, a certificate may be reliable enough when issued but come to be unreliable sometime thereafter. If the subscriber loses control of the private key, the digital certificate has become unreliable, and the certification authority (either with or without the subscriber's request depending on the circumstances) may suspend (temporarily invalidate) or revoke (permanently invalidate) the certificate. Immediately upon suspending or revoking a digital certificate, the certification authority must publish notice of the revocation or suspension or notify persons who inquire or who are known to have received a digital signature verifiable by reference to the unreliable certificate.

One of the problems that are only now becoming apparent is the issue of expiration of a digital certificate. This issue must be addressed because electronic documents are being stored for decades. What is needed is a system and method that will enable authentication of a digitally signed document many years from the time of its creation.

### BRIEF SUMMARY OF THE INVENTION

It is an object of the present invention to provide a system and method for authentication of digitally signed documents after expiration of a related digital certificate.

It is another object to provide a system and method for authentication of digitally signed documents after the signatory is not in a same position or has left an organization.

It is another object to provide a system and method for authentication of digitally signed documents after the signing entity is no longer in existence.

In a preferred embodiment, the present invention is a system for verification of a digital signature when 1) a digital certificate has expired and not been renewed, 2) a signatory has left or has a different position within an organization, or 3) the signing entity is no longer in existence, wherein the system eliminates the need to renew digital certificates, while still providing long-term authentication of digital signatures.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an example of a document having embedded digital signature in an XML D-SIG format.

FIG. 2 is a block diagram of a signature operation.

FIG. 3 is a block diagram of a signature operation.

FIG. 4 is a block diagram of a signature operation.

FIG. 5 is a block diagram of a signature operation.

FIG. 6 is a block diagram of an e-notary signature operation.

FIG. 7 is a block diagram of a verification operation.

FIG. 8 is a block diagram of a verification operation.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

The presently preferred embodiment of the invention is a system and method for authentication of a digital signature when events have occurred that typically result in a digital signature no longer being capable of authentication. There are various events that can occur which will prevent authentication. These events include, but should not be considered limited to, 1) expiration of a digital certificate, 2) a signatory leaving or having a different position within an organization, or 3) the signing entity no longer being in existence.

The loss of the ability to authenticate a digital signature can have serious consequences in this age of electronic documents. Accordingly, what is needed is a system and method that will enable authentication of digital signatures long after common circumstances arise in business that would result in the digital signature not being verifiable. Corporations are formed and just as quickly disappear from existence. People are put in positions and leave them very rapidly. Furthermore, digital certificates have a set lifetime of operation, and must be renewed or be considered unreliable.

It should also be apparent that in a large organization, the number of documents that require digital signatures can grow exponentially. Thus, the cost of digital certificate renewal can also grow exponentially.

These and other factors make it essential that some system be provided to enable authentication of digital signatures long after the digital signature is created, but also reduce the cost of maintenance of the digital signatures. Such a system should guarantee that decades later, the digital signature can be verified. This ability to provide long-term authentication may even be a requirement when dealing with certain organizations, such as governments.

It has been suggested but not explicitly stated that digital signatures should never be trusted if they cannot be authenticated because of expiration of the signer's digital certificate. The present invention provides a system and method for long-term authentication even after digital certificate expiration.

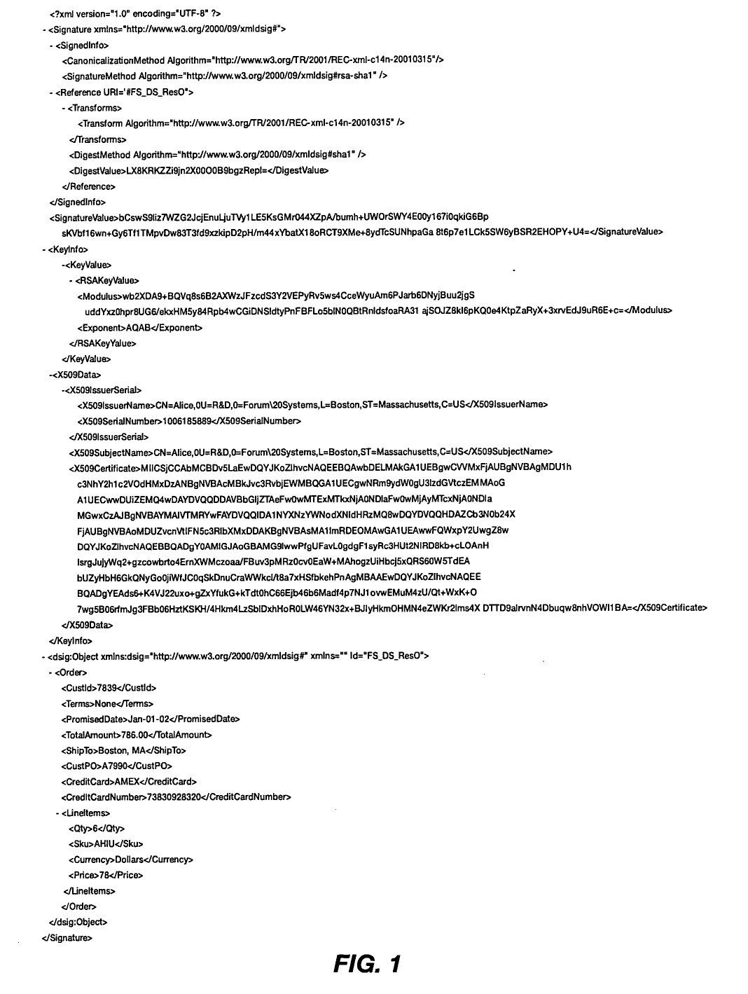

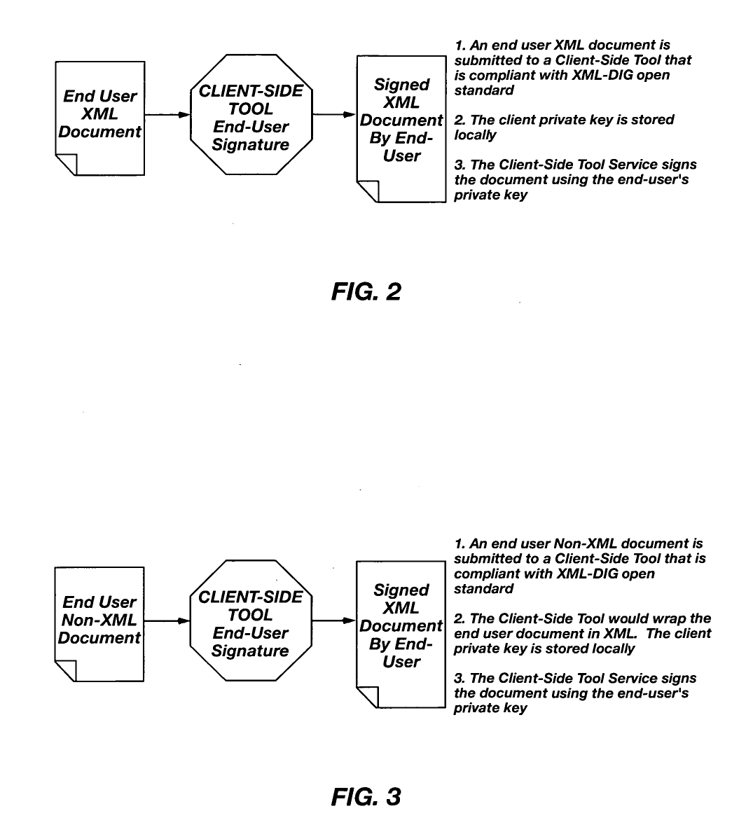

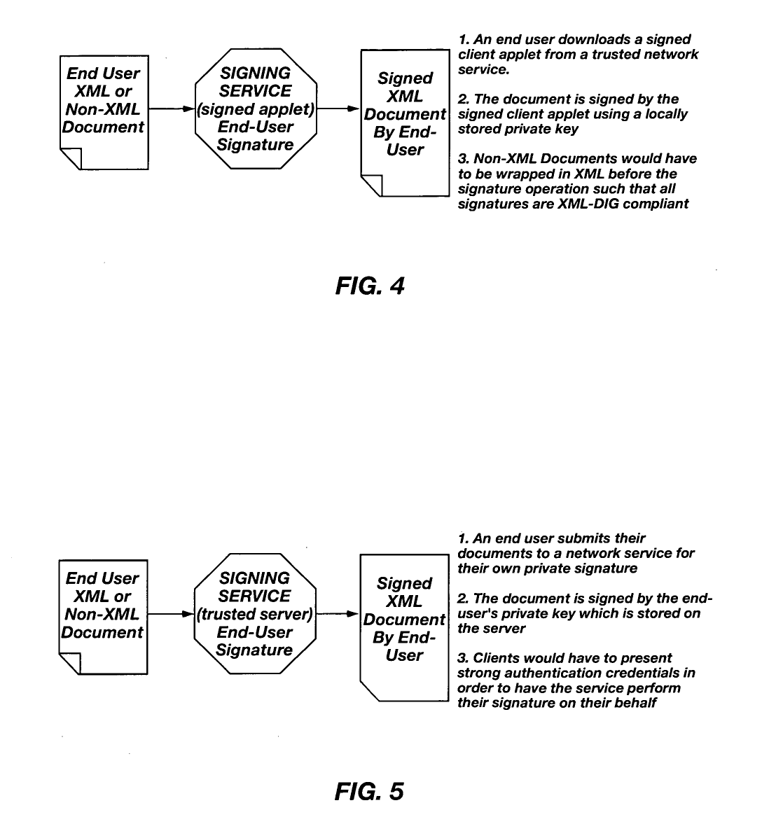

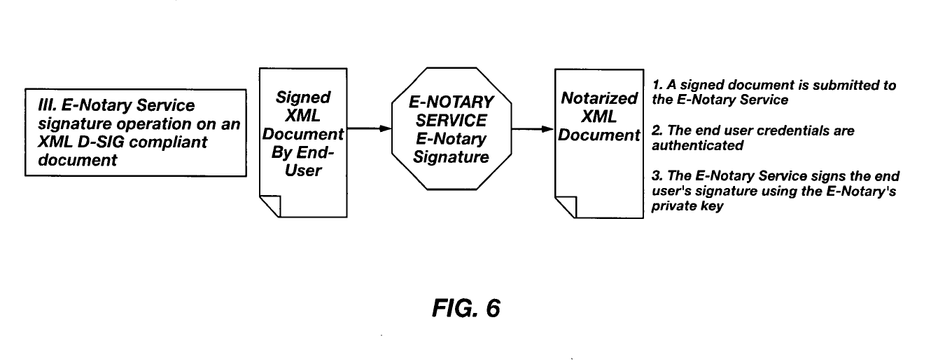

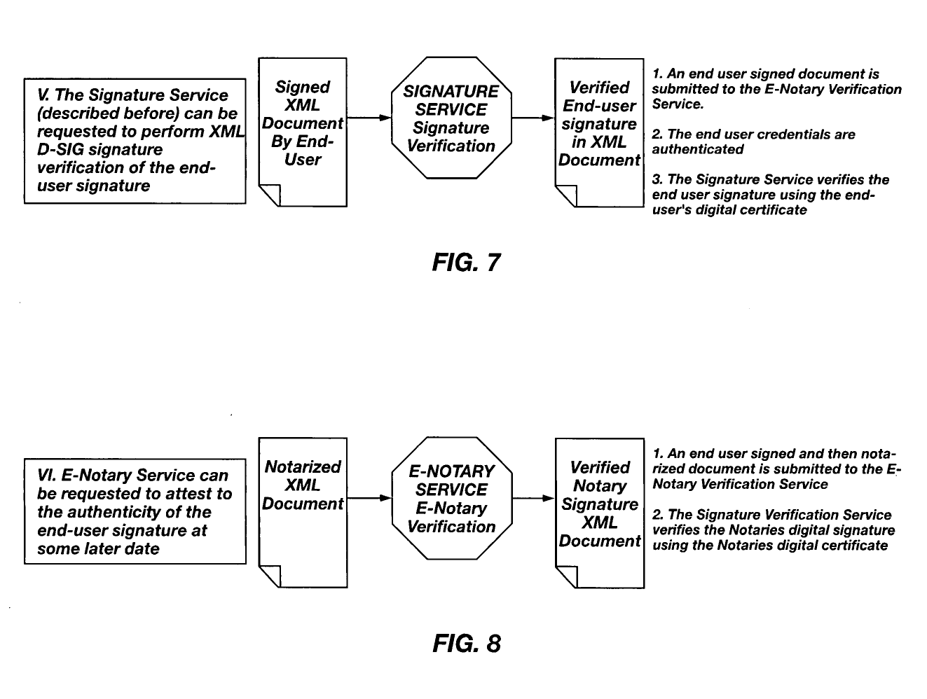

Electronic documents that have been digitally signed will contain embedded digital signatures in an XML D-SIG format. See FIG. 1. The digital signature provides verification that the intended signer was indeed the entity that signed the document, thus providing authentication. Upon verification of the signature, it can also be determined if the data has been tempered with, thus providing assurance of data integrity.

The end-user's digital certificate which contains the public key of the signer is used during the digital signature verification process. This process includes the step of validating the digital certificates time expiry and authenticity. However, if the authenticity of the digital certificate cannot be determined upon checking with the issuer of the digital certificate (for example, because of expiration), then the digital signature verification process is void.

In the physical world, notary publics are used to serve as impartial and unbiased witnesses during the manuscript signing of documents by identifying the signatory. The purpose of the notary public is to prevent fraud through attestation of the identity of the signatory. This is accomplished by appearing in person before the notary public, displaying valid identification, and then signing in the presence of the notary public.

In essence, the critical elements of this process are 1) affirming that the signatory signed in the presence of the notary, 2) recording the time (date) of the event, 3) signing the document, and 4) keeping a record of the event.

The present invention is an electronic equivalent of the steps described above, but using digital signatures, the public key infrastructure, and electronic databases to provide the notary functions of a notary certificate, identification of the signer, a notary journal for recording the event, and neutrality of the notary to the event. Specifically, a digital signature of the notary functions as a notary certificate, a properly used digital certificate of the signatory serves as a proper identification at the event, a database of the signature and optionally the original document would function as the notary journal, and the notary would serve only as an impartial witness to the event, not to the contents of the document.

The essence of the e-notary system and method of the present invention is the validation of the e-notary's signature for a relatively long period of time, if not forever. The e-notary's signature would affirm or authenticate the validity of the digital signature of a document, regardless of the expiration of the digital certificate of the signatory.

In other words, both the end-user digital signature and the digital certificate applied to a document can be used for authenticating the document at any point in time, even if the digital certificate has expired.

The mechanics of the system and method can be described as follows. First, the end-user signatures might be applied by a client-side tool or by a server (a network service) on behalf of the client. In any of these scenarios, the end-user private keys can be stored locally at the client or at the server. In the latter scenario, the client would be required to present strong authentication to the server. Clients outside the scope of the system can participate in the system as long as they are compliant with the XML D-SIG standard, or equivalent should the standard change.

Second, there are at least two entities involved in the system: the end-user and the e-notary. The end-user is the entity that has the signature authority on a document; the e-notary will affirm and attest that the end-user has digitally signed the document. There may be a need for a custodian or trustworthy third party depending upon the business model. In general, the fact that the e-notary's certificate is valid should be sufficient to enable notarization. There may also be a need for a separate Signature Service as will be explained later in this document.

Third, the document will be signed in the presence of the e-notary, or not in the presence of the e-notary. The difference is that the end-user digital signature services can be offered by the e-notary. In both scenarios, the authenticity of the signed document is ascertained by first verifying the end-users digital certificate, and then verifying the end-users digital signature on the document.

It is noted that the sender is not necessarily the signer of the document. What is important is that the signer be verified, and not the sender.

Fourth, before notarizing an end-user's digital signature, the e-notary service is first required to establish the authenticity of the end-user. This step is performed by validating the end-user's digital certificate. The authenticity of the end-user can also be performed with extended credentials, such as a SAML token bounded to a digital certificate that is embedded in the document.

Fifth, after validation of the end-user's digital certificate, the e-notary verifies the digital signature of the end-user on the document. This step guarantees that the end-user is the signatory of the document. The e-notary will then sign the end-user's digital signature and digital certificate.

By signing the end-user's digital signature and digital certificate, the e-notary is guaranteeing 1) that the end-user's digital signature and digital certificate cannot be altered, and 2) that the end-user digitally signed the document.

The process of authenticating the document first involves verification of the digital signature of the e-notary's digital signature. A custodian acting as a third party will be involved as an unbiased entity to verify the signature of the e-notary. The verification of the e-notary signature on the document thus authenticates the digital signature and digital certificate of the end-user. This authentication is valid regardless of whether or not the digital certificate has expired, because the e-notary digital signature can be authenticated.

It should be noted that the e-notary is not responsible for the integrity of the document. However, the e-notary's digital signature on the end-user's digital signature and digital certificate can be used to determine the integrity of the document.

An important aspect of the invention is the realization that the e-notary's digital certificate used for verification is long-lived, which accordingly results in the e-notary's digital signature being valid for the life-time of the end-user document. Thus, the life span of the end-user's digital certificate becomes irrelevant to the e-notary verification process.

An overview of the process quickly shows the advantages of the present invention. Digital certificates expire, and must be regularly renewed. There may be many digital certificates that must be tracked for documents. A large number of documents will likely result in a large number of digital certificates. These digital certificates may not be renewable for many reasons, such as if the entity is dissolved. But a single e-notary service is able to authenticate each and every document, even if each document has a different digital certificate. All that is necessary is that the digital certificate be valid at the time of signing.

There are various alternative embodiments that should be considered for the present invention. The present invention envisions a system that can also provide auditing, logging, and archiving. This system is referred to as e-journaling. The archiving operation anticipates the storing of entire end-user documents or subsets of documents with the digital signatures.

In addition, any of the e-journaling functions might be separated from the e-notary process, but instead be part of a corporate workflow environment. Furthermore, it is envisioned that the functions of e-journaling might be disabled, or portions activated for particular documents, in accordance with selectable system or corporate policies.

For example, the strength of authentication needed should be flexible in order to be able to respond to a given situation. Consider a purchase order under $100. A username and password may be sufficient to enable the system to sign a purchase order. However, a smart chip with a private pin number might be required for authenticating an individual who desires to sign a purchase order for a million dollars. The degree of authentication would be a customer-changeable option.

There could also be multiple end-user digital signatures on a single document, either for the same end-user, or for different end-users. Each end-user digital signature would be notarized and time-stamped. Therefore, some interface would need to be provided for enabling multiple policies to be enforced on a single document.

It is envisioned that there is a separation between e-notary services, and signing/signature services.

The e-notary master keys (the public and private keys) would mostly likely be generated on an e-notary service server. For example, a PKCS #10 request is then formulated and sent to the CA server using, for example, HTTP SSL. The e-notary master keys are long-lived and would have some life-cycle themselves, such as a ten year period. All sensitive keying material should be stored on a hardware security module such as that provide by nCipher.

Key revocation could be managed via Certificate Revocation Lists stored in an LDAP server and fetched and refreshed on the e-notary service server.

Standards-based interoperability should be included in the design and implementation. Open technical specifications including XKMS should be considered as a longer term strategy specifically for simplifying key management and PKI integration.

Regarding deployment issues, e-notary would preferably reside beside the CA with mirror instances for no single point of failure. In addition, there is a need for multiple e-notary Instances including:
E-notary copy that would exist at a trusted third party
Back-up servers for failures, with a replica of keying material and policies
Redundancy independent of geography, preventing single point of failure
Global load balancing to prevent overload on any single system

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for verifying a digital signature on a document after expiration of a digital certificate, said method comprising the steps of:
1) applying end-user signatures on a document by a client-side tool or by a server on behalf of the client
2) signing the document in the presence of an e-notary;
3) verifying the end-user's digital certificate;
4) verifying the end-user's digital signature on the document;
5) validating the end-user's digital certificate; and
6) signing the end-user's digital signature and digital certificate by the e-notary
